(19) United States
(12) Patent Application Publication
(10) Pub. No.: US 2006/0201174 A1
(43) Pub. Date: Sep. 14, 2006

(54) Rotating vane blend door

(75) Inventors: Steven B. Marshall, Oxford, MI (US); Joseph J. Spryshak, Hartland, MI (US); Richard Sikorski, Macomb, MI (US)

Correspondence Address: Valeo Climate Control Corp.;Intellectual Property Department, 4100 North Atlantic Boulevard, Auburn Hills, MI, 48326, US

(73) Assignee: Valeo Climate Control Corp., Auburn Hills, MI (US)

(21) Appl. No.: 11/079,622

(22) Filed: Mar. 14, 2005

(51) Int. Cl. F24F 7/00; F25D 17/04; B60H 1/32

(52) U.S. Cl. 62/186; 236/49.3; 62/244

(57) ABSTRACT

The present invention relates to air distribution for vehicle heating, ventilation and air conditioning systems having a preferably semi-lateral HVAC architecture configuration. The semi-lateral HVAC system provides for a bend or turn in the housing between the evaporator and heating means of the HVAC unit wherein a rotational device with moveable vanes is located, to provide improved air flow temperature and flow control over traditional lateral HVAC architectures, while employing less space and a lower piece count.

### FIELD OF THE INVENTION

The present invention relates to air conditioning systems, and, particularly, automotive air distribution system having HVAC units.

### BACKGROUND OF THE INVENTION

HVACs, and particularly units for conditioning air in motorized vehicle or similar applications, often are required, for packaging or efficiency reasons, to be constructed with preferably lateral or semi-lateral architectures. By lateral architectures it is meant that the evaporator is situated such that the airflow direction through the evaporator is lateral (from side to side as opposed to fore/aft) with respect to the vehicle and the airflow downstream of the heater core continues in a mostly lateral direction prior to reaching the outlet of the HVAC unit. By semi-lateral architectures, it is meant that the evaporator is situated such that the airflow direction through the evaporator is lateral with respect to the vehicle and the airflow downstream of the heater core does not travel appreciably in a lateral direction prior to reaching the outlet of the HVAC module.

In the HVAC semi-lateral architecture type, the air must make a bend or change direction at an angle that can be on the order of approximately 90 degrees between the evaporator region and the heater core region as it approaches the outlet ducts which provide the conditioned air to the interior areas of the motorized vehicle. The typical door rotating axis from the prior art, which is not normal to the incoming air velocity vector, and typical doors, have to have a separate mechanism upstream to change the direction of the air so that the airflow direction is more directed to the door rotating axis. Semi-lateral HVAC architectures are particularly advantageous when it is desired to create separate temperature control zones for the left and right sides of the vehicle. In this case, the design of the semi-lateral architecture allows the temperature doors, heater core, air mixing chamber, and distribution doors to be arranged very in a manner convenient for separating the left and right airflow and allowing the temperature difference from the left to right side of the vehicle. Semi-lateral HVAC architectures are also advantageous when the packaging space in vehicle is limited. For example, there is often only a small space available for the HVAC unit wherein a transmission tunnel, in-car entertainment equipment, or low instrument panels are part of the design of the vehicle.

In lateral and semi-lateral HVAC architecture designs, air flow, after being conditioned in the region of the evaporator and/or heater core, needs to be directed to outlets serving various areas of the vehicle interior. For example, the air flow downstream of the evaporator and/or heater core generally needs to flow into panel, floor, and/or defrost ducts on both the right side and left side of the interior of the vehicle. A great problem has been to balance the air flows both left and right, as well as to provide for air of the desired temperature to create zones of comfort for the driver as well as any passenger or passengers in the vehicle. In traditional lateral and semi-lateral HVAC architecture designs, the air in the conditioned airflow is often ‘imbalanced’ from both a flow and a thermal point standpoint. Often, it is difficult with the lateral architectures to overcome the momentum of the air traveling towards the center of the vehicle so that some of the air reverses direction to travel back towards the outboard duct outlet, near the point of origin. The result is that more flow reaches the opposite (typically driver's) side of the vehicle and there is not a desirable left to right balance of airflow, creating uncomfortable condition for one of the front seat occupants.

Fixed vanes have often been used to attempt to correct this imbalance, but in the modern, compact areas available for HVAC units, temperature control curves (TTC) and individual airflow quantities (IAQ) cannot normally be achieved by a single fixed vane system. Another system is, therefore, warranted.

### SUMMARY OF THE INVENTION

An objective of the present invention is to give good control over the airflow quantities that eventually outlet the HVAC by providing for a system that control airflow that feed the heater core and the cold path or mixing chamber. It is intended to give good left to right flow balance both in airflow quantity and air temperatures at the outlet of the HVAC unit. The present invention also allows for a reduction of door closing complexity and piece count. The present invention, provides for a system that allows the best aerodynamic path for air flow in both hot and cold temperature positions of the HVAC unit, while maintaining a functional air path and flow structure in the mid blend control positions also. The present invention, therefore, offers the advantages of compactness, door count reduction, and integration of features within a rotation device (rotating vane blend door), thereby providing a semi-lateral architecture to be used where normally such an architecture would be unable to have the control of flow or temperature distribution as in a full lateral HVAC unit.

The present invention, therefore, presents not only advantages such as compactness, part reduction and simplicity (versus the prior art), but also air flow control, directivity and flow uniformity.

The present invention provides for a flexible or guidable system which solves the unbalance problem of the prior art for HVAC architectures which require airflow to turn direction significantly prior to, or in conjunction with, valving the airflow between two or more airpath directions, such as between hot and cold paths for temperature control. By providing for a flexible or guidable system, the present invention has the advantages of providing for a single blend door versus multiple blend doors as seen in the prior art; a flow turning device, which produces airflow at the outlet that is typically perpendicular (or any other specific angle) to the incoming airflow; and a means to provide a uniform air velocity distribution at the outlet. The outlet airflow is then conditioned properly in uniformity and direction to optimally take advantage of downstream devices such as a baffle, particularly a mixing baffle or cross flow baffle, and/or the heater core region. The motion of the rotating vane barrel door can be through an electrical actuator, pneumatic actuator, direct cable connection to the user control, or any other device creating the desired movement.

The present invention provides for a compact and simplified solution which reduces both the number of parts and the complexity of the lateral or semi-lateral HVAC unit. It allows for a gradual shift of the flow from the hot path to the cold path in the HVAC unit in the following manner: first, the rotating vane blend door is positioned fully in one direction, in which it blocks flow to and seals the cold path, and opens airflow to the hot path. In this position, the vanes inside the rotating vane blend door turn the air from the direction parallel to the incoming air direction to a direction parallel with the direction ideal for the hot path. This change in direction can variable and can even be on the order of 90 degrees. Also in this position, the vanes turn the air in a uniform manner to achieve outlet airflow velocity uniformity.

Also in preferred embodiments of the present invention, the rotating vane barrel door is positioned such that it is rotation is partially between the full extremes of motion. In this position, neither the hot or cold airflow paths are sealed, and airflow is allowed to both paths, in a volumetric proportion related to the proportion of the angle between the two directions. In this position, the vanes inside the rotating vane blend door turn the air from the direction parallel to the incoming air direction to a direction between the direction ideal for the hot path and direction ideal for the cold path, in a proportion related to the positional proportion of the rotating vane door. Also in this position, the vanes turn the air in a uniform manner to achieve outlet airflow velocity uniformity.

In preferred embodiments of the present invention, the rotating vane blend door even positioned fully in a direction in which it blocks flow to and seals the hot path, and opens airflow to the cold path, provides advantages. In this position, the vanes inside the rotating vane blend door turn the air from the direction parallel to the incoming air direction to a direction parallel with the direction ideal for the cold path. Also in this position, the vanes turn the air in a uniform manner to achieve outlet airflow velocity uniformity.

The characteristics of the rotating vane barrel door as described above allow an improved air temperature control and left to right airflow balance in the semi-lateral HVAC unit. Compactness due to reduction in door count and the reduction in linkages between the doors with improved flow control, add to the improvements over the present technology.

The present invention further provides for a system that can turn and/or direct air at the desired apertures or openings (for example, to separate hot and cold paths, or to separate HVAC outlets such as panel bound air and floor bound air) when requested or required to do so. In other words, a manual cable or electronic controller, actuator or similar device controlled the turnings or directing of upstream air towards the hot path and or cold path or both by a set or a series of turning vanes is preferred. The turning vanes, preferably are included, more preferably are integral with, in a rotating vane blend door, more preferably a rotating vane blend barrel door, most preferably a rotating vane blend door having a cross flow baffle or interior air mixing device downstream the vane blend stream door and upstream of the distribution area of the HVAC unit. By rotating vane, it is meant that the vanes change orientation corresponding to the motion of the door. By interior air mixing baffle it is meant a device such as cross flow baffle or mixing baffle or other air directing surfaces which force separate incoming hot and cold airstreams to combine such that the air at the outlet has a desired temperature uniformity and desired temperature bias towards one (or more) particular direction(s).

In preferred embodiments of the present invention, more than one turning vane, preferably a set of two or more turning vanes, more preferably a plurality of turning vanes, are included in a rotation device such as a door, more preferably a blend door, even more preferably a blend door in a shape of a barrel, wedge or shell, a so called ‘barrel door’. In cold mode, at least one, and, preferably, a set of two or more turning vanes, even more preferably, a plurality of turning vanes, most preferably essentially all turning vanes, are moved i.e. turned or rotated to point the flow towards the cold path, the flow having come from a lateral direction and then turning more perpendicular in the semi-lateral HVAC unit towards the cold outlet side. In the hot mode the same set of vanes are rotated about the axis of the incoming air towards the heater core. Likewise, the rotating device can position the vanes so that the flow is pointed towards the appropriate direction in the HVAC unit in the full hot, full cold modes or so called mixed or blended modes, or modes wherein the air is controlled in fixed ratios of hot and cold. A mixed or blended mode, therefore, leads to a mixture of quantities and/or temperatures of air in the distribution area prior to leaving to HVAC unit. Air leaving the region of the vanes is, thereby, pushed or fed into the distribution area, preferably into a mixing baffle prior to reaching the distribution area. The mixing or cross flow baffle, as describes in the US Patent Application Publication 2003/0201096A1 (co-pending application Ser. No. 10/134,692 filed Apr. 30, 2002, Perry et al) leads to airflow with more even temperature air emerging from the merging region within the baffle. By forcing air from a first air flow to mix with a second air flow, proximate a merging region, by arcuate passageways, or scoops, or other similar means, the mixing device, and particularly the cross flow mixing baffle in preferred embodiments of present invention, preferably provides for an even smoother distribution of air than possible in other lateral or semi-lateral HVAC units due to the combination of the upstream rotation vane door and the cross flow or the mixing device. In preferred embodiments, a rotating device with vanes, and a cross flow baffle form a system in conjunction with one another in a compact lateral or semi-lateral HVAC unit.

Air entering the region of the rotation device (and in particularly preferred embodiments, the rotating vane barrel door), enters at various velocities and volumes. Air flow is regulated by passing through the vanes to provide generally uniform velocity distribution exiting the device either in the hot or cold air path. By providing the rotation device at the angle of turn of the semi-lateral architecture HVAC the equivalent of good lateral temperature characteristics is provided due to the good lateral flow characteristics of flows downstream of the rotation device.

As previously described, these lateral temperature characteristics are achieved with a minimum number of doors in the HVAC unit, such door count reduction resulting in cost saving for the HVAC unit. The chosen mode describes can be determined by the operator of the controls of the HVAC unit.

### BRIEF DESCRIPTION OF THE DRAWINGS

FIG. 1 is a schematic view of a blend door with vanes and pins, and an HVAC housing found around such door in a compact or semi-lateral HVAC unit, in accordance with an aspect of the present invention.

FIG. 2 is a schematic view of an HVAC unit with evaporator and heater core, showing the conditions where the rotating vane barrel door is applied, in accordance with an aspect of the present invention.

FIG. 3 is a schematic, cut-away view of an HVAC unit with rotation device with vanes positioned to receive air flows, in accordance with an aspect of the present invention.

FIG. 4 is a schematic view of an HVAC unit with rotational device and actuator, in accordance with an aspect of the present invention.

FIG. 5 is a cut-away view of an HVAC unit showing effect of vanes on air flow in the hot path position. The vanes shown are integral with the barrel shaped door (not shown) in accordance with an aspect of the present invention.

FIG. 6 is a cut-away view of an HVAC unit showing effect of vanes on air flow in cold path position. The vanes shown are integral with a barrel shaped door (not shown) in accordance with an aspect of the present invention.

FIG. 7 a-c are schematic diagrams showing the positioning of vanes in rotation device of a semi-lateral HVAC unit in full cold (a), 50% hot (b) and full hot position (c), in accordance with an aspect of the present invention.

FIG. 8a-c are schematic cross sectional views of a semi-lateral HVAC unit with heater core and distribution area, in full cold (a), 50% hot (b) and full hot (c) modes, in accordance with an aspect of the present invention.

FIG. 9a-c are center-line schematic views of a semi-lateral HVAC unit with sealing surfaces, door and caps, heater core and distribution areas, in full cold (a), 50% hot (b) and full hot (c) modes, in accordance with an aspect of the present invention.

FIG. 10 is an exploded schematic view of a semi lateral HVAC system, having a cross flow baffle downstream of vanes, with air directed towards the baffle, in accordance with an aspect of the present invention.

FIG. 11 is an exploded schematic view of a semi lateral HVAC system, having a cross flow baffle downstream of vanes, with air directed towards the baffle, in accordance with an aspect of the present invention.

### DETAILED DESCRIPTION OF THE INVENTION

In preferred embodiment of the present invention, vanes are located in a rotation device, in a form of a barrel, wedge, or cylinder, or the like cylinder, which rotates. Preferably the vanes are integral with the rotation device. In such embodiments, the vanes move as part of the rotation device, such as the rotational device can be a barrel door with vanes for example. In other preferred embodiments, the rotation device may be designed so that the van or vanes are separate from the door so that the vanes rotate independently. In more preferred embodiments, the set of at least two vanes, allow air in an air flow downstream to an evaporator to be ‘turned up’ from the evaporator. The vanes in the rotation device are rotated about or turned on an pivoting axis that is nearly parallel with the incoming air flow from the evaporator. By rotating the vanes, downstream air flow is directed towards hot and/or cold paths. Also in a preferred embodiment, where the vanes are integral with the barrel door, the vanes always turn the air towards the outlet direction of the door.

In preferred embodiments, the vanes are rotated so that rotation allows for many positions i.e. mixed temperatures or quantities air between so called ‘full hot’ and ‘full cold’ positions. The present invention, in preferred embodiments controls the flow into the heater core and thereby, also, preferably, controls temperature. In addition, the present invention provides the desired affect of efficiently turning the airflow in the necessary direction and simultaneously provides a means of achieving desired velocity profiles (typically uniform velocity) in the desired orientation at the outlet of the device. In the more preferred embodiments, the rotation device itself can be rotated along its own axis or axes while the vanes turn in directions different from that of the rotation device. In a hot mode, most if not essentially all of air flow passes through or around the heater device.

In other preferred embodiments of the present invention, door edges or sealing surfaces, can function, for the purposes of the invention, like a barrel door in so as far as allowing air flow into only certain regions. In preferred embodiments, a long main sealing surface and a rotating arch seal are found on the ends of the vane and housing. In cold mode only applications, the sealing surface touches a sealing, and more preferably a plane surface of the housing and the area of contact, acts in a way that the hot path is sealed closed; in the hot mode, the opposing sealing surfaces touch their matching sealing, and preferably plane or planar surfaces of the housing, so that the cold path is sealed closed. In such embodiments, the rotation device need not to be solid, but for example, could be more skeletal in nature; in more preferred embodiments, the structure of the rotation device has vanes such that the device is a rotating vane blend door, and, in particular, a skeletal rotating vane blend door.

The rotation device has a structure which allows it to rotate along an axis to provide different positioning of the rotation device, and, any vanes present in the rotating device in relation to the device and the air flows to the device. Preferably, a barrel door or the like is provided to perform the rotary action. Preferably, the rotation device does not comprise a central support or structure that would hinder the flow feeding the vanes. In preferred embodiments of the present invention, the rotation about the axis occurs by means of locating the interfacing contact between the rotating vane barrel door and the surrounding structure around, but not on the axis. This allows unobstructed airflow through the axis of rotation. Preferably the points of contact are found in some sort of grove or tracks that allow it to rotate without hindering the flow. More preferably two or more points such as pins, ribs, bars or the like should be used on each end track or groove. The pins are preferably positioned on a pitch circle diameter. As can be appreciated, therefore, the rotation device can, therefore, in preferred embodiments, also move in various directions along specific axes, as well as rotating along its own proper axes.

In preferred embodiments of the present invention, the embodiments are used to allow blends of air within the HVAC unit for eventual distribution to other parts of the motorized vehicle. Other embodiments of the present invention allow the rotation device with vanes to function both with airflow direction the opposite as that previous described, such that air flows in one of two positions, depending on the rotation device and, (more preferably, the rotating vane barrel door) position, and then flows to a single, constant outlet, regardless of door position. For example, in preferred embodiments, the system of the present invention employing the rotation device can be used for the fresh and/or recirculation air intake to the HVAC, and then direct the air into the blower. Other embodiments utilize fresh and recirculation air in a pull through architecture. In more preferred embodiments, the present invention employing the rotation device is also used to feed air more uniformly to distribution areas or zones, or, preferably to distribution areas or chambers such as the satellite type distribution chambers away from the normal core of the HVAC unit (i.e. outside of the housing area that has the evaporator, heater core and the like).

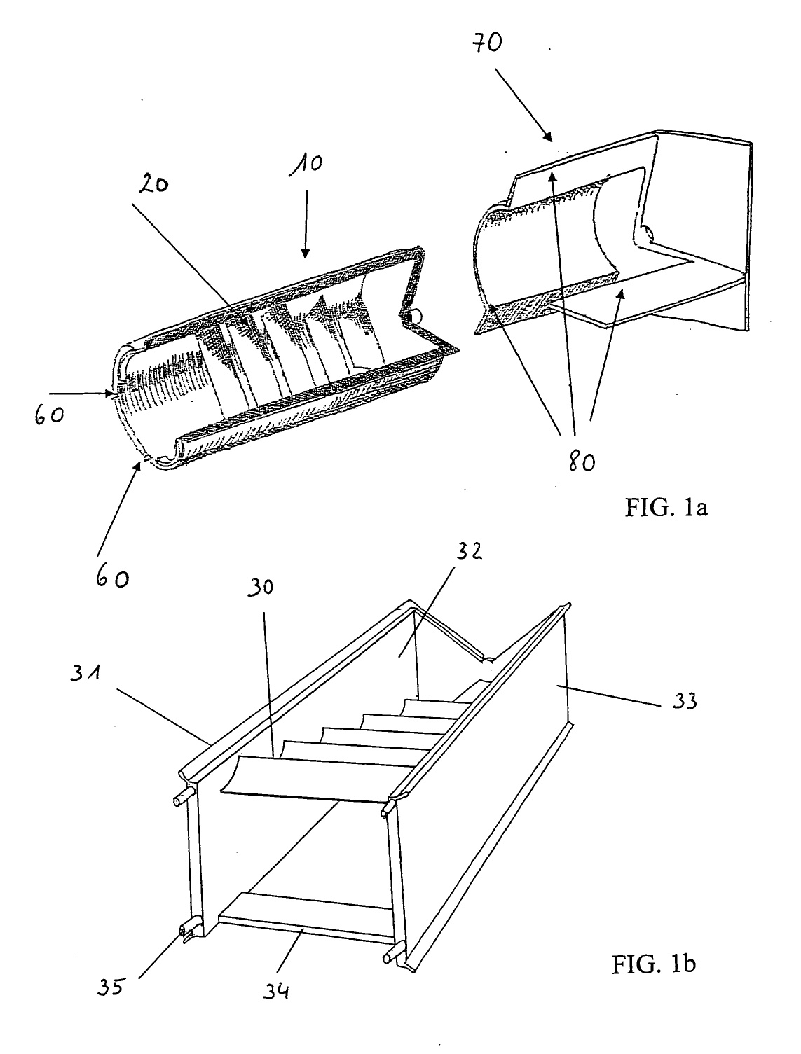

FIG. 1a shows rotating barrel door (10) having vanes (20) and pins (60) for guiding the rotating barrel door (10) specially to various positions. The air inlet to the door is identified by (AA). The air outlet of the door is identified by (BB). Housing (70) shows sealing surfaces (80) which contact the door along the door seal surface to prevent airflow to one of the two outlet positions when the door is in oriented to one of the limits of rotation. There are sealing surfaces on the door (81), axles (82) and bearings (83). FIG. 1b also shows a skeletal rotation device (90), in particular, a skeletal rotating vane door (90) with turning or rotating vane (30), a seal (39), and door surfaces (32, 33), and a structural support (34) and pin (35), that provides for a skeletal structure, in accordance with a preferred embodiment of the present invention.

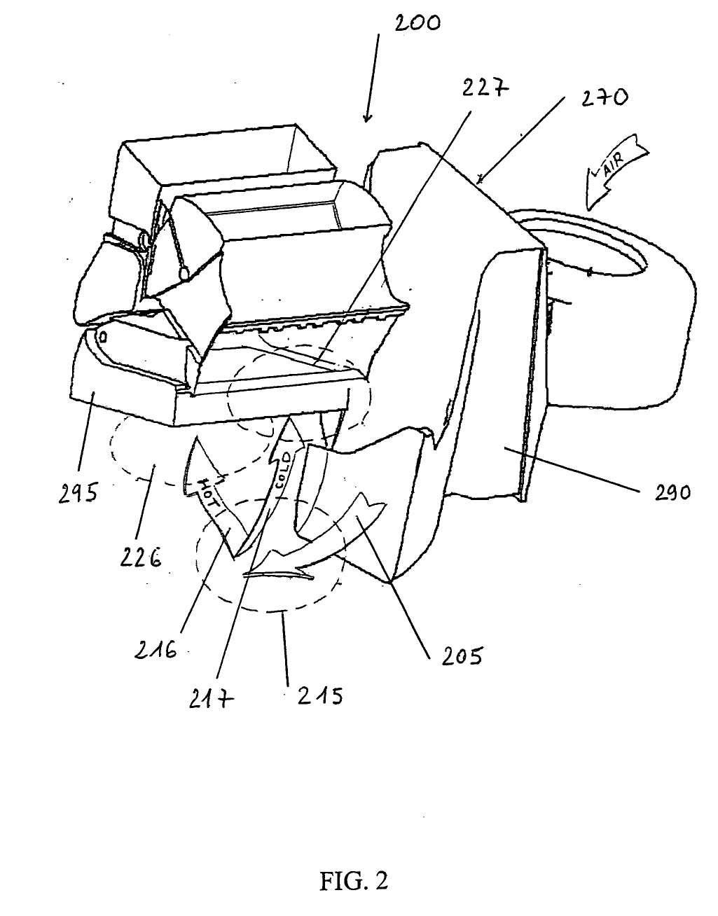

FIG. 2 shows an HVAC system (200) having a housing (270) (evaporator), evaporator (290) heater core (295) and distribution ducts (296), panel/vent duct feed (291), defrost and demist duct feed (292), floor duct feed (293), and distribution region (294).

An air flow (205) downstream of the evaporator (290) and upstream of the rotation device or air turning zone (215), after passing the air turning zone (215) continues either to a hot path (216) leading to the heater core, or a cold path (217) bypassing the heater core, or a mixture of the two depending of the mode setting. Hot path distribution zone (226) (air passes through the heater core) and cold path distribution zone (227) are downstream of the hot path (276) and cold path (217) respectively. Note that the hot path (216) and cold path (217) are somewhat normal to the inlet air flow (205). The cold and hot path air mixes in approximate ratios depending on blend door position.

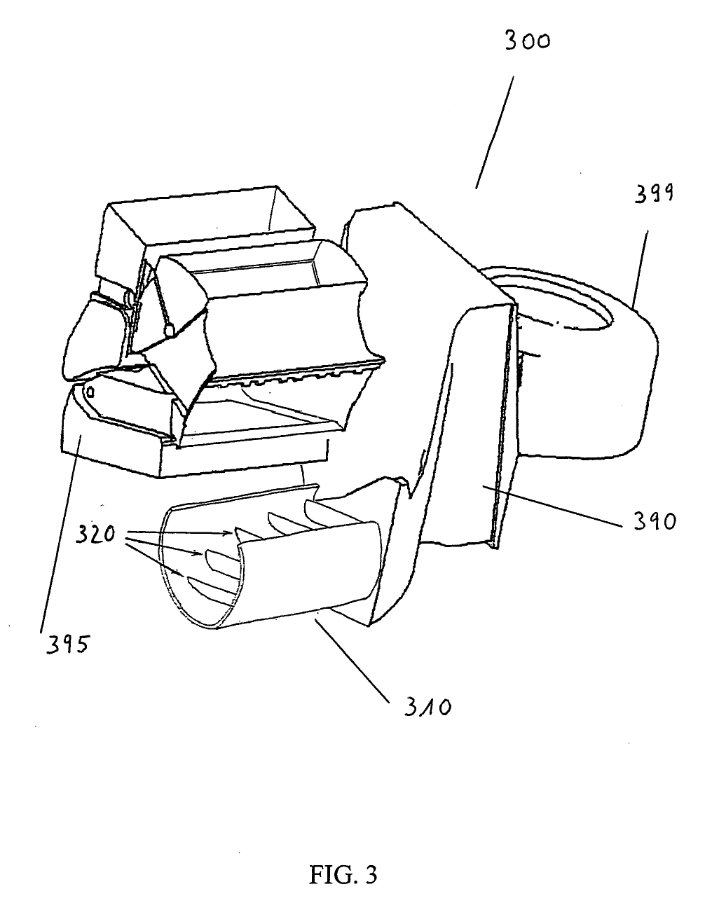

FIG. 3 shows HVAC system (301) with rotating vane barrel door (300) and vanes (320) in turning air zone (302) of the HVAC unit. Scroll area (399) distribution region (305) duct feeds (308,309,310) evaporator (390) and heater (395) are illustrated.

In an embodiment such as FIG. 2, a general description of a functioning mode is as follows: Incoming air from the evaporator entering the zone 1, where the air must be directed to either the zone 2 for the hot path or zone 3 for the cold path.

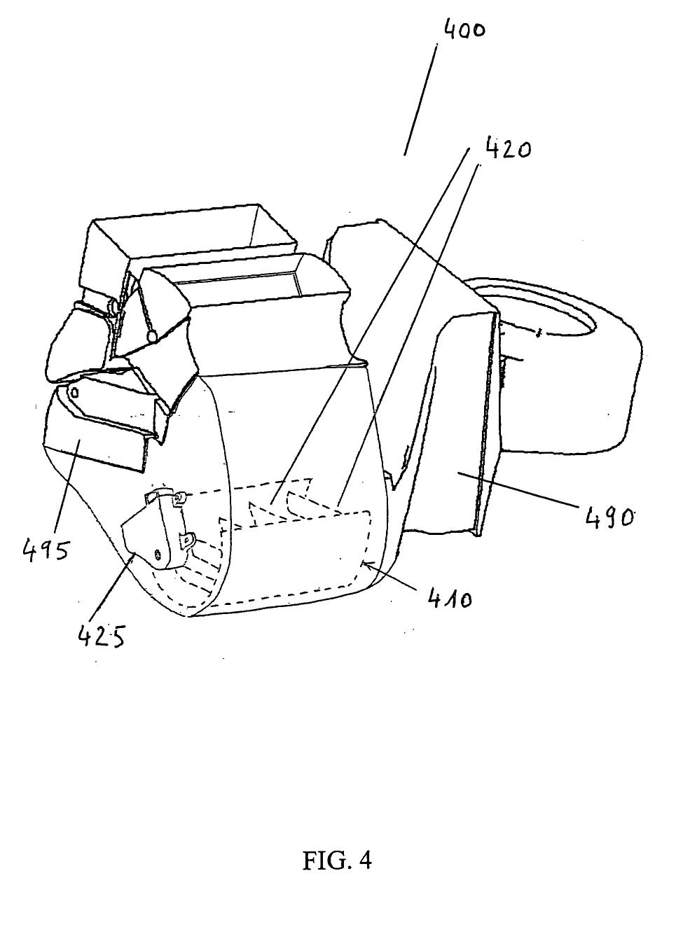

FIG. 4 illustrates HVAC system (400) with evaporator (490) and heater core (495), with rotating vane door (410) with integral vanes (420), being controlled by a controller or actuator (425) in order to rotate the vane door (410) relative to the housing (412).

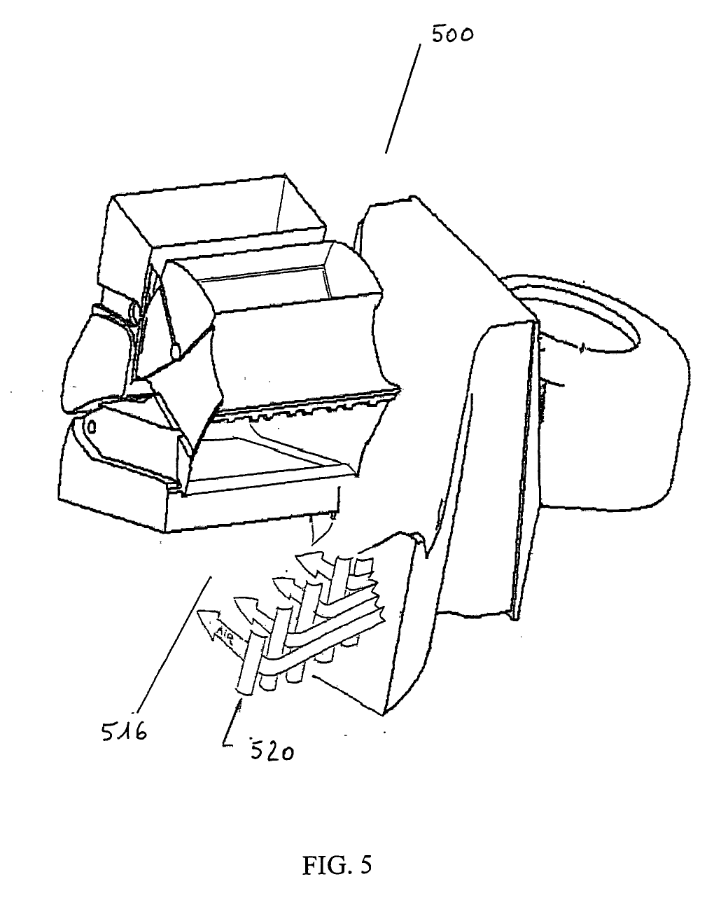

FIG. 5 illustrates the HVAC system (500) with vanes (520) integral to the door in hot path (516) position (the door not shown in the illustration). The rotating vane barrel door is in position to allow uniform flow to the hot path and prevent flow to the cold path.

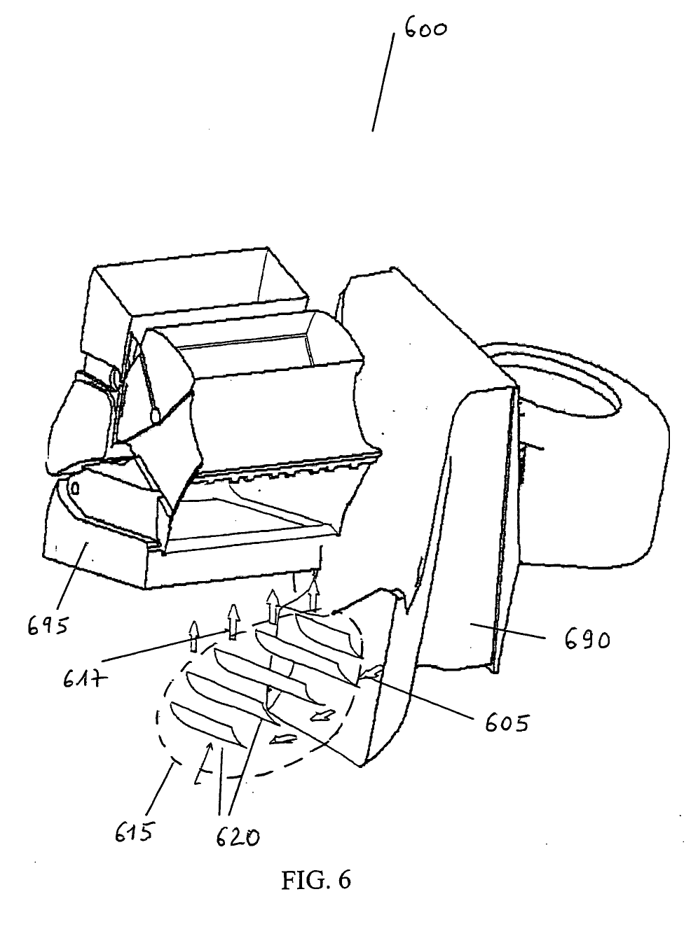

FIG. 6 illustrates HVAC system (600) with evaporator (690) and heater core (695) with air path (605) upstream of the turning air zone (615), and vanes (620 integral to the door in cold path (617) position upstream of distribution region (619) (the door not shown in the illustration). The rotating vane barrel door is in position to allow uniform flow to the cold path and prevent flow to the hot path.

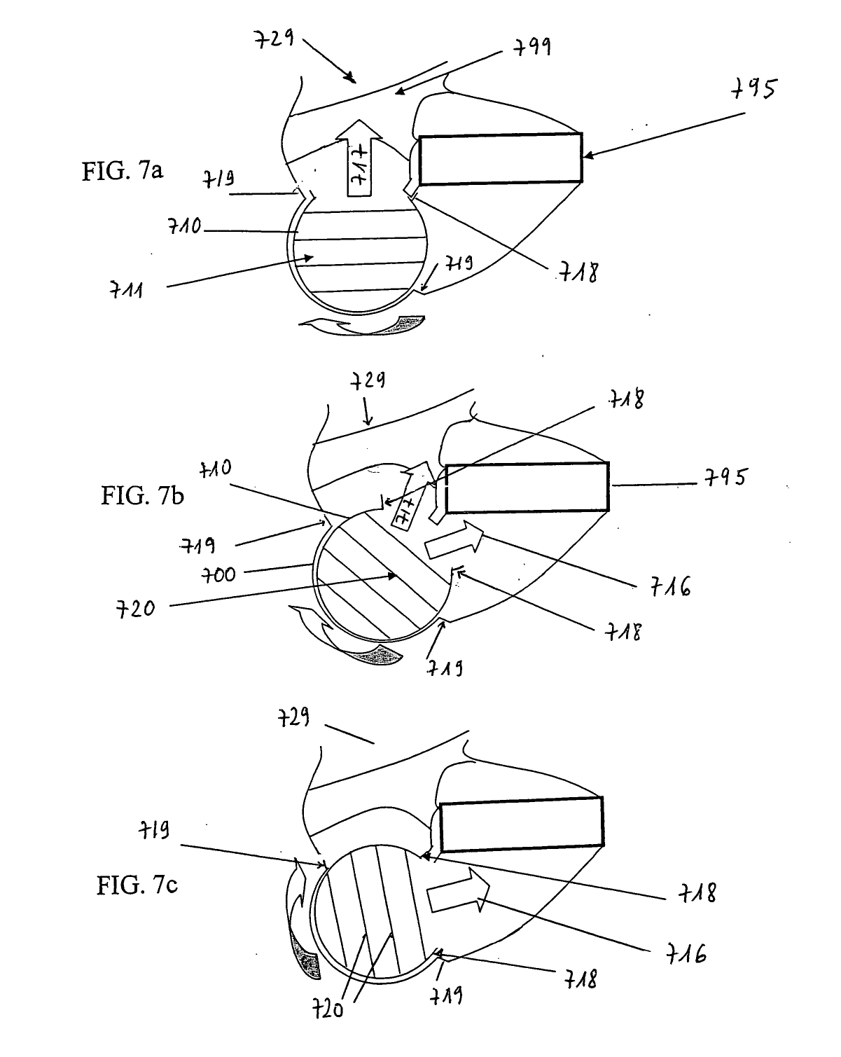

FIGS. 7a, b and c illustrate heater core (795), downstream vane barrel door from device rotation (710), air downstream from the evaporator (705), entering rotating device (710) in airflow area (711) with vanes (720) shown on end view directing air into the hot path (716) or both (716,718), depending on the mode setting. Lateral sealing faces (718) are shown, as found in barrel door. Distribution area (719) is also shown.

In FIG. 7a, all air flow bypasses the heater core, in cold mode. Lateral sealing faces (718) are showing, with corresponding faces and planes forming a seal to allow all air in air path to pass through the cold path (717).

In FIG. 7b, the lateral sealing faces (718) and planes (719) do not form a seal, so air flows in both cold path (717) and hot path (716), in blend mode. In FIG. 7c, all air flow passes through the heater core, in hot mode. Lateral sealing faces (718) are showing, with corresponding faces and planes forming a seal to allow all air in air path to only pass through the hot path (716).

Optional cross flow baffle (interior air mixing baffle) (799) serves to provide desired temperature uniformity or bias of air flow downstream of the rotating vane barrel door device, and upstream of the distribution air zone (729), is placed in zone (799) prior to the distribution area.

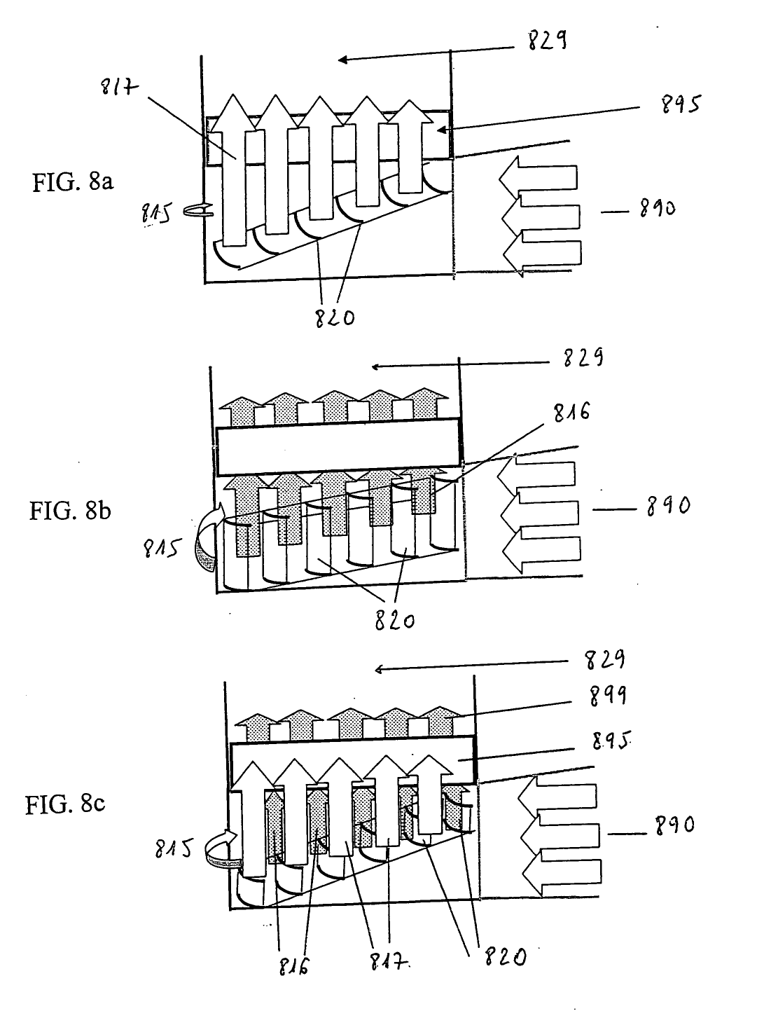

FIGS. 8a, b and c, show air flow into vanes (820) from the evaporator region (890). Air turns in turning zone (815) up, and, preferably, at an angle towards the perpendicular towards the distribution area (829).

FIG. 8a shows full cold mode, where all air bypasses the heater core (895), and follows the cold path (817).

FIG. 8b illustrates a full hot mode where air flow (890) enters into the rotated vanes (820), then turns, preferably at an angle up towards the perpendicular, hot flow (816) towards the distribution area (829).

FIG. 8c illustrates a mixed or 50% hot mode, wherein air flow enters the rotated vanes (820) and then part of the flow turns towards the heater (895) hot flow (816) and some cold flow (817) joins post evaporator air (899) towards the distribution area (829) for mixing.

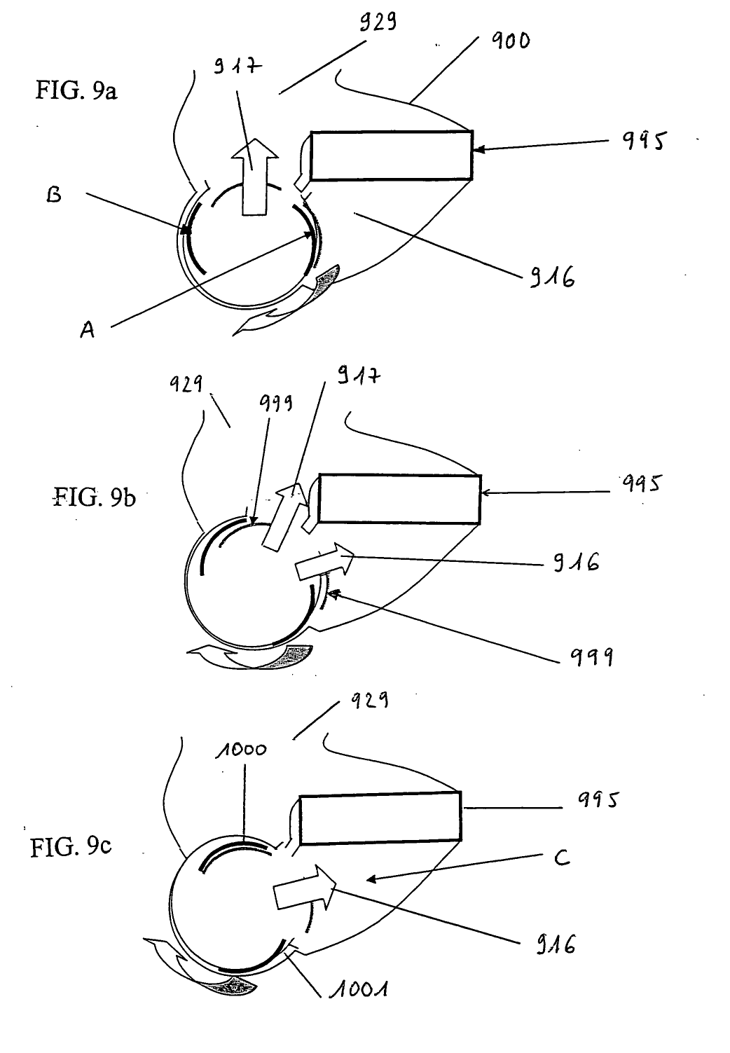

FIGS. 9a, b and c, show another embodiment of an HVAC system in approximately center line view with housing (900), heater core (995) and sealing features (AB) comprising sealing surfaces in an end cap shape on the door and fixed parts on the housing (999). The sealing features have rotating arch shape and turn about the central axis of the rotating vane barrel door.

In FIG. 9a, the hot path (916) is sealed closed, the cold path (917) is open to the distribution area (929) (full cold mode).

In FIG. 9b, is illustrated 50% hot mode. The sealing plane or similarly fixed part of the housing (999), forms a part of the end of the sealing feature or end cap, the sealing feature allowing rotation and sliding of the corresponding sealing surfaces axis 902 the planes so that the cold path (917) and hot path (916) remain partially open to respectively allow air to the distribution area or to the heater core (995) prior to reaching the distribution area (929).

In FIG. 9c, illustrates full hot mode position of the end cap sealing surface and sealing surface features (1000,1001).

Most, if not all air flow leaves the turning area after passing through or around the vaned rotation device (1001). Flow enters the heater core (995), and basically all air flow (C) bypasses the cold path (917) i.e cold path sealed, but hot path (916) open.

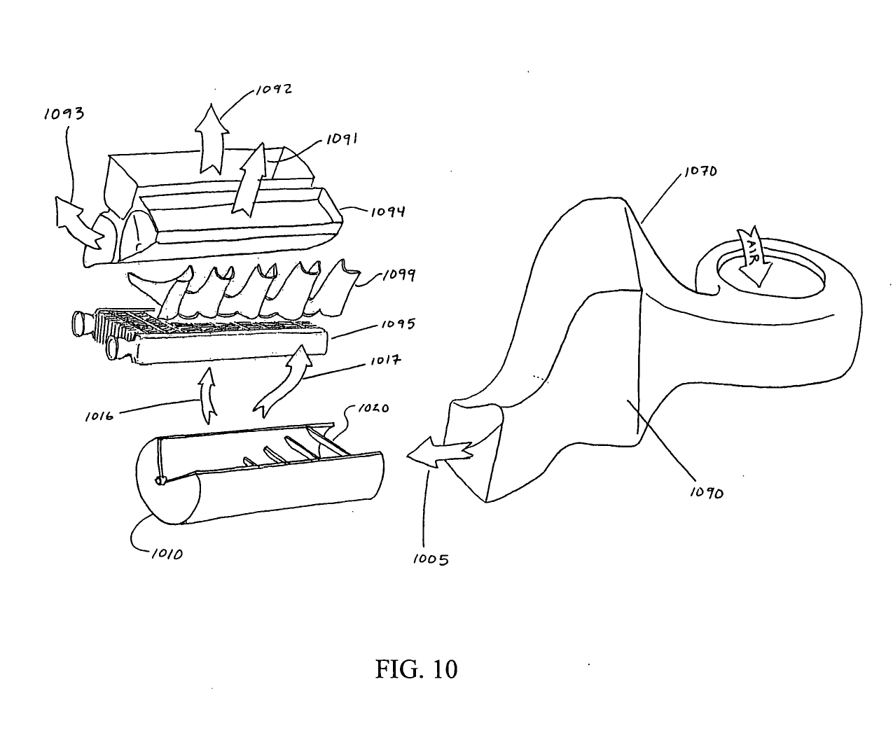

FIG. 10 shows a semi-lateral HVAC architecture with upstream air flow (1005) passing through rotation device (1010) and be directed by vanes (1020). In cold mode downstream airflow (1017) is directed to cross flow baffle (1099) which is held in the HVAC unit and receives air for distribution though distribution unit (1094), prior to distribution through distribution duct feeds (1091,1092,1093). In hot mode downstream airflow (1016) is directed to the heater core (1095) and on to the cross flow baffle (1099) and continues as in cold mode.

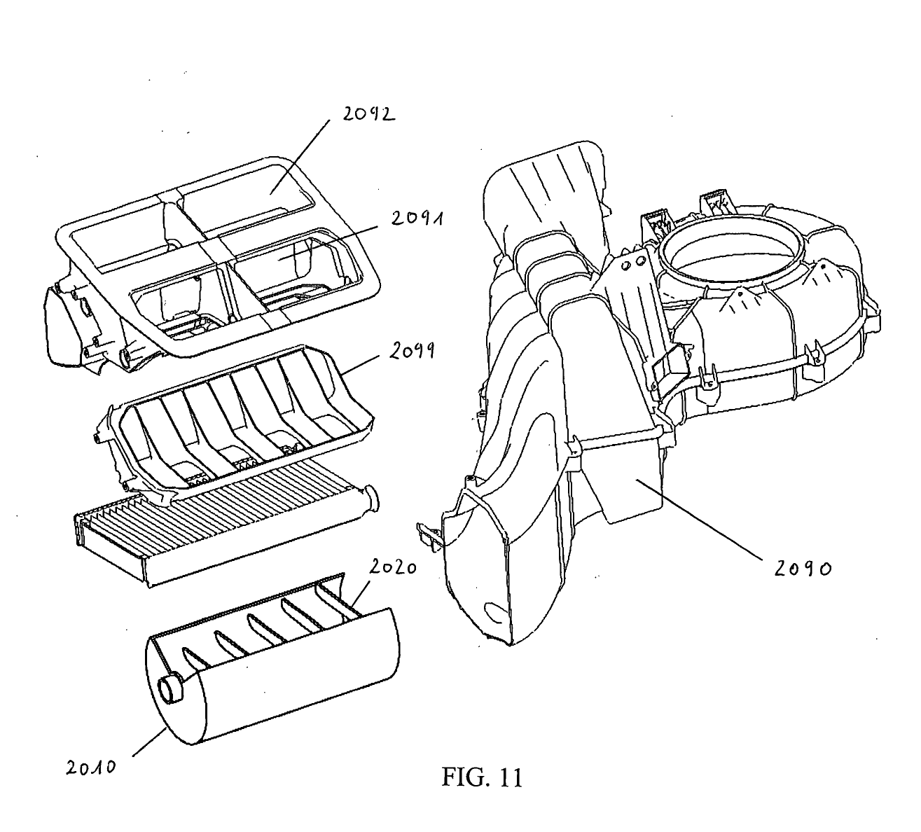

FIG. 11 shows a semi-lateral HVAC architecture with upstream air flow (2005) passing through rotation device (2010) and be directed by vanes (2020). In cold mode downstream airflow (2017) is directed to cross flow baffle (2099) which is held in the HVAC unit and receives air for distribution though distribution unit (2094), prior to distribution through distribution duct feeds (2091, 2092, 2093). In hot mode downstream airflow (2016) is directed to the heater core (2095) and on to the cross flow baffle (2099) and continues as in cold mode.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. An air distribution system for a vehicle heating, ventilation and air conditioning system having an semi-lateral HVAC unit comprising:
an HVAC housing;
a heater;
an evaporator in an evaporator area of the housing;
a rotation device;
a vane;
an air distribution area;
a bend or turning area of the housing at the area between the evaporator means and the heating means of the housing;
wherein the rotation device is located in the turning area between the evaporator means and the heating means, and wherein at least one vane is located on the interior surface of the rotation device.

2. An air distribution system according to claim 1 wherein the rotation device rotates or translates around at least one axis.

3. An air distribution system according to claim 2 wherein the rotation device is a door that rotates around at least two axes.

4. An air distribution system according to claim 2 wherein the rotation device has at least one moveable vane and a plurality of vanes.

5. An air distribution system according to claim 4 wherein at least two vanes are oriented to be parallel with the inflow and outflow requirements to follow the contours of each other.

6. An air distribution system according to claim 5, wherein the at least two vanes are oriented such that they deflect air coming from the evaporator area towards the air distribution area.

7. An air distribution system according to claim 6 wherein the vanes deflect the air at an angle at or about 10 to about 170 degrees.

8. An air distribution system according to claim 7, wherein the vanes deflect the air at an angle at or about 45 to 135 degrees.

9. An air distribution system according to claim 7 wherein the vanes deflect the air at an angle at or about 90 degrees.

10. An air distribution system according to claim 1 wherein the vane is moveable.

11. An air distribution system according to claim 10 wherein there are at least two vanes and the vanes move to be positioned along the axis of the air in the airflow.

12. An air distribution system according to claim 11 wherein the movement of the vanes is controlled by a controller or actuator.

13. An air distribution system according to claim 6 wherein the rotation of the rotation device is controlled by a controller or actuator.

14. An air distribution system according to claim 12, wherein the rotation device is controlled by a controller or actuator.

15. An air distribution system according to claim 10, wherein the system further comprises a cross flow baffle or internal air mixing device.

16. An air distribution system according to claim 15, wherein the cross flow baffle or interior air mixing device is found in the housing area between the rotation device and the distribution area.

17. An air distribution system for a vehicle heating, ventilation and air conditioning system having an semi-lateral HVAC unit comprising:
an HVAC housing;
a heater;
an evaporator;
an area of the housing defining a bend or turning area;
at least two sealing surfaces on the interior of the housing at or near the bend or turning area;
a rotation device having at least two sealing surfaces;
a vane located on or connected to the interior of the rotation device;
wherein the bend or turning area of the housing is located at the area between the evaporator means and the heating means of the housing; and the rotation device is located in the turning area between the evaporator means and the heating means.

18. An air distribution system according to claim 17, wherein the rotation device sealing surfaces and the housing sealing surfaces correspond to each other in such a way that they come together to form a partial or complete air seal on either end of travel.

19. An air distribution system according to claim 17, wherein the sealing surfaces and the housing surfaces are oriented such that when at least one sealing surface and at least one housing surface come together to form a partial or complete air seal, that either all air flow coming through the housing of the HVAC from the evaporator towards the distribution area is cold air flow or all air flow coming through the housing of the HVAC from the evaporator towards the distribution area is hot air flow.

20. An air distribution system according to claim 19, wherein the rotation device rotates around at least one axis.

21. An air distribution system according to claim 20 wherein the rotation device translates or rotates around at least two axes.

22. An air distribution system according to claim 20 wherein the rotation device has a plurality of vanes and wherein at least two vanes are oriented to be generally parallel with each other in such a way that they deflect air coming from the evaporator area towards the distribution area.

23. An air distribution system as in claim 19, further comprising an interior air mixing baffle.

24. An air distribution system according to claim 1 wherein the rotation device is a skeletal rotating vane blend door.

25. An air distribution system according to claim 17 wherein rotation device is a skeletal rotating vane blend door.

26. An air distribution system according to claim 23 wherein the air flows towards the distribution area are subsequently directed in a balanced manner to the left or right driver side and left or right passenger side of the conditioned air distribution system.

27. A method of providing air through an automotive semi-lateral HVAC unit comprising:
providing outside or recycled air to the evaporator region or area of the HVAC unit;
guiding the air from the evaporator region or area to a zone or region downstream of the evaporator region or area wherein a rotation device is located;
rotating the vanes in the rotation device so that the air from the evaporator region or areas passes through the vanes and is directed to or turned in a turning area to be directed, in a fairly uniform manner, towards an area downstream of the turning zone or area and downstream of the distribution area of the HVAC;
moving or turning the rotation device and/or the vanes so that the airflow reaching the distribution area is provided at a desired temperature uniformity and temperature bias in one or more directions, depending on the mode desired by the operator of the controls of the HVAC unit.
